(19) United States
(12) Patent Application Publication
(10) Pub. No.: US 2004/0071201 A1
(43) Pub. Date: Apr. 15, 2004

(54) Method for testing a mobile radio system

(76) Inventor: Gunther Klenner, Rosenheim (DE)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/469,244

(22) PCT Filed: Mar. 11, 2002
(86) PCT No.: PCT/DE02/00849

(30) Foreign Application Priority Data
Mar. 14, 2001 (DE) 101 12 607.7

(51) Int. Cl. H04Q 1/20; H04B 3/46

(52) U.S. Cl. 375/224

(57) ABSTRACT

The invention relates to a method for testing a mobile radio system with a test transmitter (11), whereby the mobile radio system has at least one fixed station, which transmits in a first frequency range, and has a multitude of mobile stations, which can transmit and receive, whereby a mobile station transmits in a second frequency range. The aim of the invention is to achieve a simple and cost-effective determination of the radio illumination and radio communications quality for an already established mobile radio system and even for the designing and modification of such a mobile radio system. To this end, the test transmitter (11) has a transmitting device that transmits signals in the first and second frequency ranges to at least one measuring receiver (12).

The present invention relates to a method for testing a mobile radio system using a test transmitter, with the mobile radio system comprising at least one fixed station which transmits in a first frequency range (downlink) and comprising a plurality of mobile stations which can transmit and receive, with a mobile station transmitting in a second frequency range (uplink) . The present invention also relates to a test transmitter as claimed in the precharacterizing clause of patent claim 14, and to a measurement receiver as claimed in the precharacterizing clause of patent claim 15. Finally, the present invention relates to a test system as claimed in the precharacterizing clause of patent claim 16.

Mobile radio networks such as these which use different frequency bands for downlink transmission and for uplink transmission are known from the prior art and are referred to as frequency division duplex (FDD) mobile radio networks. The present invention can be used equally well for mobile radio networks which are installed within a building as for mobile radio networks which are used outdoors. Three important mobile radio systems which are covered by the expression TDMA systems (TDMA=Time Division Multiplex Access) differ in the frequency range which is intended to be used for the downlink and uplink, as is shown in the following table:

| | GSM | DCS 1800 | PCS 1900 |
|---|---|---|---|
| Uplink | 890-915 MHz | 1710-1785 MHz | 1850-1910 MHz |
| Downlink | 935-960 MHz | 1805-1880 MHz | 1930-1990 MHz |

There are, of course, many other mobile radio systems, such as CDMA and TDMA systems, PCS systems in accordance with the North American digital mobile standard, or else the FDMA system which is used in the Nordic mobile telephone (NMT) system and which use different frequencies or frequency bands for the uplink and downlink.

The above-mentioned mobile radio systems are particularly subject to the problem of determining the propagation conditions and the communication quality. A conventional method for propagation determination for this purpose uses special mobile communication means such as test mobile telephones, which set up a two-way link with a base station. This point-to-point connection is then measured, and the demodulated/decoded data stream is assessed.

The introduction to the description in the document WO 99/13669, for example, discloses the use of a continuous wave (CW) test transmitter and a test receiver for checking the cell subdivision before the installation of antennas. Analog RF signals are used in this case. The test transmitter is positioned where the base station or the antenna is intended to be set up, and the signal transmitted by the test transmitter is recorded at various positions using the test receiver. In this case, however, all that is carried out is a pure propagation measurement of the test transmitter, and the field strength is measured only at the location of the mobile station.

The problem of the location at which the fixed stations or antennas, which are all connected to a fixed station, should be set up also arises in particular before setting up, or extending a system such as this. The planner of the mobile radio system can on the one hand use his experience for this purpose, or can carry out a software simulation. In this case, the actual environment in which the base station or antennas will be placed should be simulated on the basis of mathematical models. A digital “map” of the environment is produced, and parameters such as attenuation or damping by obstructions such as buildings, and the signal power of the antennas, can be varied. Fixed stations are then set up in the simulated environment, and the signal power is measured at a number of spatial points. The parameters can be varied, and antennas can be moved in the simulated environment, etc. during the measurement.

However, it has been found in practice that neither experience nor the simulation or tools mentioned above give a good result. Parameters such as the attenuation of RF interference must be estimated or predicted, and these estimates will differ to a greater or lesser extent from the true values. In particular, difficulties occur when the number of users of the mobile radio system increases.

The object of the present invention is therefore to avoid the disadvantages of the prior art and, in particular, to allow in a simple and cost-effective manner the radio illumination and radio communication quality to be provided for a mobile radio system which has already been set up, and for planning and modifying such a mobile radio system.

The object according to the invention is achieved for a method of the type mentioned initially by the test transmitter comprising a transmitting device which transmits signals in the first and second frequency ranges to at least one measurement receiver.

One particular advantage of the present invention is that the propagation conditions and the communication quality are determined without having to set up an actual radio link. This means that the local measurement data recording is carried out purely passively and without the transmission signals, thus precluding in particular any risk to health to those recording the measurement data due to high radio wave intensities.

The transmitting device of the test transmitter preferably transmits signals from the first and second frequency ranges alternately. This means that both the uplink area and the downlink area can be measured easily and quickly, and, to a first approximation, this allows conclusions to be drawn about the communication quality since, in comparison to the prior art, the uplink channel is also taken into account.

The signals which are transmitted from the transmitting device of the test transmitter are preferably unmodulated. According to one advantageous development of the invention, the signals which are transmitted by the test device of the test transmitter are analog signals, in particular pulsed signals. The use of a test transmitter and measurement receiver means that there is no need to use a two-way link, that is to say communication based on the mobile radio standard of the mobile radio system that is being used, thus further precluding high radio field strengths on the person recording the measurement data. Furthermore, in this case, it is also possible to use a simple test transmitter. The requirements for the measurement receiver are likewise not stringent, due to the use of unmodulated, analog signals, in particular pulsed signals.

The signals which are transmitted by the transmitting device of the test transmitter are advantageously pulsed. The use of pulses is particularly preferable because the signals are simple to produce and the signals received by the measurement receiver are simple to evaluate. Both the radio illumination and the communication quality can thus be determined to a first approximation in a quick and cost-effective manner. In this case, it is also preferable for the pulses to originate alternately from the first and second frequency ranges.

Advantageously, the first frequency range comprises a first set of a plurality of frequencies or frequency channels and the second frequency range comprises a second set of a plurality of frequencies or frequency channels, with one respective frequency or frequency channel in the first set being associated with one respective frequency or frequency channel in the second set, thus resulting in the formation of a plurality of pairs of frequencies or frequency channels, and with the transmitting device of the test transmitter (11) alternately transmitting to the at least one test receiver on a plurality of pairs of frequencies or frequency channels.

An evaluation device which is associated with the measurement receiver preferably evaluates the received signals in order to determine the communications conditions in the mobile radio system. The evaluation device may in this case be included in the measurement receiver, or else may be formed by a measurement computer connected to it, in particular a personal computer. The received signals are stored and are compared, for example, with experimentally or theoretically predetermined nominal curves. In particular, only a comparison of the received signals with the signals transmitted by the test transmitter needs to be carried out in order to evaluate the received signals.

In this case, all the relevant parameters of the transmitted signals are used to obtain information about the propagation conditions and the communication quality.

The evaluation device advantageously evaluates the intensity of the received signals. The evaluation device preferably evaluates the distortion of a received pulse shape with respect to the transmitted pulse shape of the received signals. The evaluation device preferably evaluates any time delay to the received signals.

The test transmitter is preferably set up at at least one planned installation location for a fixed station. The evaluation device then advantageously determines the optimum location for installation of a fixed station.

According to a further aspect, the object on which the present invention is based is achieved by a test transmitter for testing a mobile radio system, with the mobile radio system comprising at least one fixed station which transmits in a first frequency range and comprising a plurality of mobile stations which can transmit and receive, with the mobile stations transmitting in a second frequency range, and with the test transmitter having a transmitting device which transmits signals in the first and second frequency ranges to at least one measurement receiver.

According to a further aspect, the object on which the invention is based is achieved by a measurement receiver for testing a mobile radio system, with the mobile radio system being tested using a test transmitter, and with the mobile radio system comprising at least one fixed station which transmits in a first frequency range and comprising a plurality of mobile radio stations which can transmit and receive, with a mobile station transmitting in a second frequency range, and with the measurement receiver receiving signals, which are transmitted by a transmitting device of the test transmitter, in the first and second frequency ranges.

According to a further aspect, the object on which the invention is based is achieved by a test system for testing a mobile radio system which comprises a test transmitter and/or a measurement receiver, as described above.

Further preferred embodiments are disclosed in the dependent claims.

The invention as well as further features, aims, advantages and application options of the invention will be explained in more detail in the following text using preferred exemplary embodiments and with reference to the attached drawings. The same or corresponding reference symbols in the drawings denote the same or corresponding elements. In this case, all the features which are described and/or are illustrated in the figures on their own or in any desired sensible combination form. the subject matter of the present invention, to be precise independently of their combination in the claim or their references back to the claims. In the drawings:

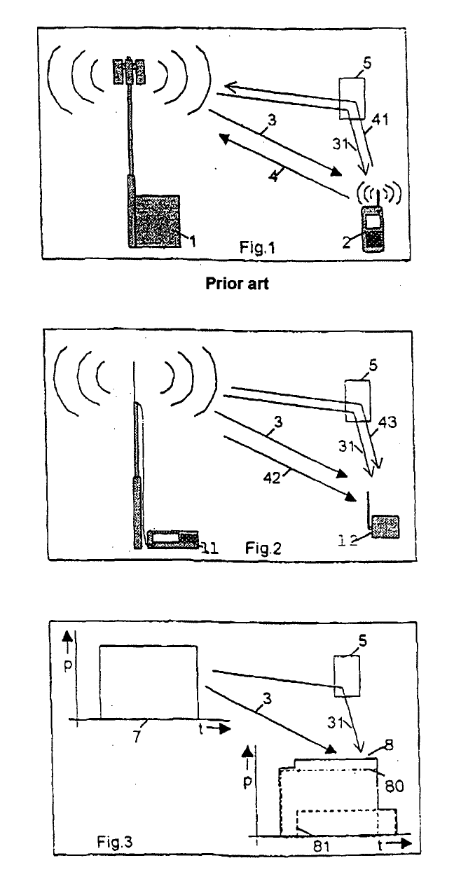

FIG. 1 shows a schematic diagram which illustrates a test method for a mobile radio system according to the prior art;

FIG. 2 shows a schematic diagram, which illustrates one exemplary embodiment of the method according to the invention for testing a mobile radio system; and

FIG. 3 shows a schematic diagram to illustrate the evaluation of the transmitted and received signals for the exemplary embodiment of the present invention as illustrated in FIG. 2.

FIG. 1 illustrates schematically how an already installed mobile radio system is tested according to the prior art. A base station or fixed station is annotated by the reference symbol 1. A mobile station 2, which is used as a test mobile, is located in the area covered by the fixed station 1. For radio measurement, that is to say in order to make statements about the communication conditions, about the communication quality of the location of the fixed station 1, and about their performance with respect to their area of coverage, a radio link, that is to say a two-way link, is set up between the fixed station 1 and the mobile station 2. This means that the data stream which is set up between the fixed station 1 and the mobile station 2 is coded and decoded in accordance to the mobile radio system that is used. The data link is bidirectional, that is to say signals are transmitted from the fixed station 1 via what is referred to as the downlink or forward channel 3 to the mobile station 2. Transmission likewise takes place from the mobile station to the base station on the uplink or reverse channel 4. The transmission on the uplink channel 4 in particular results in the person recording the measurement data being subjected to high radio field strengths. In very many mobile radio systems, the frequency range for the downlink channel 3 is not the same as that for the uplink region 4. Only the field strength of the location of the mobile station 2 is typically determined in order to make a first statement about the quality of the radio link. This pure field strength measurement cannot provide unambiguous and conclusive statements about the communication conditions, particularly in environments with multipath links. This is due to the fact that multipath links can be caused, for example, by a reflection on an obstruction. This results in particular in phase cancellations or amplifications, which can severely adversely affect the communication quality. In this context, it should be noted that the reflection factor which describes the reflection on the obstruction 5 is generally a function of the frequency. To illustrate this better, the drawing shows a second radio path 31 from the fixed station 1 to the-mobile station 2, and a. second radio path 41 from the mobile station 2 to the fixed station 1, which is produced by a reflection on the obstruction 5. The influence of the second reflected signal 31 on the signal 3 which is received by the mobile station 2 is not the same as that of the reflected signal 41, which was transmitted by the mobile station, on the signal 4 which was transmitted directly by the mobile station 2.

It is likewise known from the prior art, for example in the document WO 99/13669 cited initially, for a test transmitter to be used instead of the fixed station 1. However, this modified measurement technique does not allow either the reception strength or the reception quality to be determined at the position of the fixed station 1. This would not be possible until the final extent level with measurement functions at the measurement station 1, although this would require an enormous level of infrastructure complexity and would not be financially worthwhile.

A first exemplary embodiment of the present invention is shown schematically in FIG. 2. The method according to the invention is particularly suitable for the purpose of testing a mobile radio system before it is actually installed, in order in this way to determine the optimum position for a fixed station or an antenna. The present invention uses a test transmitter 11 for this purpose, which transmits CW signals with a variable amplitude. A measurement receiver 12 with a high measurement speed is used for receiving the signals transmitted by the test transmitter. The arrangement which is shown in FIG. 2 allows statements to be obtained about the communication conditions and about the communication quality. In contrast to the method shown in FIG. 1, the present invention is based on the use of a test transmitter 11 which can be positioned in different locations and which, in particular, does not have a reception capability. It is thus only possible to transmit data unidirectionally from the test transmitter 11 to the measurement receiver 12, between the test transmitter 11 and the measurement receiver 12. According to the invention, the test transmitter 11 transmits a pulsed, unmodulated signal alternately at the downlink frequency or in the downlink frequency range, as is indicated by the arrow 3, and at the uplink frequency or in the uplink. frequency range, as indicated by the arrow 42. To a first approximation, reflections and other influences which may occur in particular on an obstruction 5 are not directional. Even though, as mentioned above, reflections on obstructions are not linear with respect to the frequency, they are, however, linear with respect to the level. It can therefore be assumed that the path loss and transmission quality from the mobile station to the base station is the same as that from the test transmitter 11 to the measurement receiver 12, assuming transmissions at the same frequency. This means that, according to the present invention, the purely passive measurement data recording at the location of the measurement receiver 12 is sufficient to obtain the required measurement results. The measurement receiver 12 can determine the field strength at both frequencies for the signals which are transmitted alternately by the test transmitter 11 at the uplink frequency and downlink frequency (42, 3). This means that it is possible to use a passive measurement at the location of the measurement receiver 12 to make statements about the propagation conditions, both for the path from the location of the test transmitter 11, that is to say in particular a location which is planned for a fixed station 1, to the location of the measurement receiver 12, that is to say the planned or possible location of a mobile telephone, as well as for the opposite direction.

According to one particular embodiment of the present invention, the communication quality is also determined in addition to the radio illumination, that is to say the measurement recording of the intensity of the signals which are transmitted by the base station 1 and by the test transmitter 11. In this context, reference should be made to the schematic illustration in FIG. 3. FIG. 3 schematically shows a pulse 7 which is transmitted by the test transmitter 11 to the measurement receiver 12. The pulse 7 is in this case shown schematically in a diagram in which the power P is plotted against time t. A pulse 7 such as this is preferably transmitted alternately in the uplink and downlink frequency ranges, in particular in respectively associated uplink and downlink pairs, by the test transmitter 11. The schematic illustration in FIG. 3 is idealized to the extent that the pulse 7 transmitted by the test transmitter 11 passes directly on the one hand via the path 3 and on the other hand indirectly, that is to say it is reflected on an obstruction 5 via the path 31, to the measurement receiver 12. The reflection on the obstruction 5 results in the signal which is transmitted via the path 31 being delayed in time or phase. The actual transmission conditions are, of course, considerably more complex, and FIG. 3 is intended only to schematically illustrate one exemplary embodiment of the present invention. The signal 8, which is likewise shown in a P-t diagram by a solid line, is that which was received by the measurement receiver 12 at its location. In the simple model on which the illustration in FIG. 3 is based, the signal 8 which is received by the measurement receiver 12 is produced by superposition or addition of the signal 80 received directly via the path 3 and the signal 81 received indirectly, that is to say via the path 31. As can be seen from FIG. 3, the directly received signal 80, which is indicated by a dashed-dotted line, has a lower intensity than the signal transmitted by the test transmitter 11. The signal 81, which is shown by a dashed line, has a considerably lower intensity than the originally transmitted pulse 7 and the directly received signal 80. Furthermore, the signal 81 also has a considerable time delay in comparison to the signal 80. The signal 8 which is actually received at the measurement receiver 12 is thus distorted with respect to the pulse 7 transmitted by the test transmitter 11. The extent of the distortion of the received sum signal 8 makes it possible to determine the reception quality, to be precise both at the uplink frequency and at the downlink frequency. The intensity for the time profile of the signal 8 can, in particular, be evaluated. It should be noted that the present invention also allows the use of a plurality of measurement receivers 12, which can all be set up at different locations for measurement of the complete area of coverage of the test transmitter, thus making it possible to measure, for example the location of a planned base station,. more quickly. Two or more test transmitters 12 can likewise be used in different positions at the same time at different frequencies, in order to obtain statements about two or more possible base station locations in one measurement process.

The invention has been explained in relatively great detail above with reference to preferred embodiments of the invention. However, it is obvious to those skilled in the art that various changes and modifications can be made without departing from the idea on which the invention is based.

1. A method for testing a mobile radio system using a test transmitter (11), with the mobile radio system comprising at least one fixed station (1) which transmits in a first frequency range and comprising a plurality of mobile stations (2) which can transmit and receive, with a mobile station (2) transmitting in a second frequency range, characterized in that the test transmitter (11) comprises a transmitting device which transmits signals in the first and second frequency ranges to at least one measurement receiver (12).

2. The method as claimed in claim 1, characterized in that the transmitting device of the test transmitter (11) transmits signals alternately from the first and second frequency ranges.

3. The method as claimed in one of claims 1 or 2, characterized in that the signals which are transmitted by the transmitting device of the test transmitter (11) are unmodulated.

4. The method as claimed in claim 3, characterized in that the signals which are transmitted by the transmitting device of the test transmitter (11) are analog signals.

5. The method as claimed in one of claims 1 to 4, characterized in that the signals which are transmitted by the transmitting device of the test transmitter (11) have pulses.

6. The method as claimed in claim 5, characterized in that the pulses originate alternately from the first and second frequency ranges.

7. The method as claimed in one of claims 2 to 6, characterized in that the first frequency range comprises a first set of a plurality of frequencies or frequency channels, the second frequency range comprises a second set of a plurality of frequencies or frequency channels, with one respective frequency or frequency channel in the first set being associated with one respective frequency or frequency channel in the second set, thus resulting in the formation of a plurality of pairs of frequencies or frequency channels, and with the transmitting device of the test transmitter (11) alternately transmitting to the at least one test receiver on a plurality of pairs of frequencies or frequency channels.

8. The method as claimed in one of the preceding claims, characterized in that an evaluation device which is associated with the measurement receiver (12) evaluates the received signals in order to determine the communications conditions in the mobile radio system.

9. The method-as claimed in claim 8, characterized in that the evaluation device evaluates the intensity of the received signals.

10. The method as claimed in claim 8 or 9, characterized in that the evaluation device evaluates the distortion of a received pulse shape with respect to the transmitted pulse shape of the received signals.

11. The method as claimed in one of claims 9 or 10, characterized in that the evaluation device evaluates any time delay to-the received signals.

12. The method as claimed in one of the preceding claims, characterized in that the test transmitter (11) is set up at at least one planned installation location for a fixed station.

13. The method as claimed in claim 12, characterized in that the evaluation device determines the optimum location for the installation of a fixed station (1).

14. A test transmitter (11) for testing a mobile radio system, in particular for carrying out the method as claimed in one of the preceding claims, with the mobile radio system comprising at least one fixed station (1) which transmits in a first frequency range and comprising a plurality of mobile stations (2) which can transmit and receive, with the mobile stations (2) transmitting in a second frequency range, characterized in that the test transmitter (11) comprises a transmitting device which transmits signals in the first and second frequency ranges to at least one measurement receiver (12).

15. A measurement receiver (12) for testing a mobile radio system, in particular for carrying out the method as claimed in one of claims 1 to 13, with the mobile radio system being tested using a test transmitter (11), and with the mobile radio system comprising at least one fixed station (1) which transmits in a first frequency range and comprising a plurality of mobile radio stations (2) which can transmit and receive, with a mobile station (2) transmitting in a second frequency range, and with the measurement receiver (12) receiving - signals, which are transmitted by a transmitting device of the test transmitter (11), in the first and second frequency ranges.

16. A test system for testing a mobile radio system using a test transmitter (11), in particular for carrying out the method as claimed in one of claims 1 to 13, characterized in that the test system comprises a test transmitter (11) as claimed in claim 14, and/or a measurement receiver (12) as claimed in claim 15.
